(19) United States
(12) Patent Application Publication
(10) Pub. No.: US 2025/0066657 A1
(43) Pub. Date: Feb. 27, 2025

(54) METHODS OF VISCOSITY MODIFICATION OF MINERAL OILS FOR IMMERSION COOLING SYSTEM

(71) Applicant: Fast Cool Co., Ltd., New Taipei City (TW)

(72) Inventors: Chih-Hsin Chen, New Taipei City (TW); Chin-Te Chen, Taoyuan City (TW); Chih-Cheng Tai, Campbell, CA (US)

(21) Appl. No.: 18/727,031

(22) PCT Filed: Jan. 6, 2023
(86) PCT No.: PCT/US2023/010283

§ 371 Date: Jul. 5, 2024

Related U.S. Application Data
(60) Provisional application No. 63/297,031, filed on Jan. 6, 2022.

(51) Int. Cl. C09K 5/10

(52) U.S. Cl. CPC C09K 5/10

(57) ABSTRACT

A mineral oil based coolant for immersion cooling systems, which contains polyalphaolefins and a modifier that lower the viscosity of the polyalphaolefins when mixed with the polyalphaolefins. The polyalphaolefins comprises poly(1-decene). The modifier comprises one or more fatty alcohols. The one or more fatty alcohols comprises four-seven carbon fatty alcohols. The four-seven carbon fatty alcohols comprise butanol or heptanol. The modifier comprises one or more fatty acids.

### CROSS-REFERENCE TO RELATED APPLICATION(S)

This application claims priority under 35 U.S.C. § 119(e) of the U.S. Provisional Patent Application Ser. No. 63/297,031, filed Jan. 6, 2022 and titled, “METHODS OF VISCOSITY MODIFICATION OF MINERAL OILS FOR IMMERSION COOLING SYSTEM,” which are hereby incorporated by reference in their entirety for all purposes.

### FIELD OF THE INVENTION

The present invention relates to the field of electronic cooling. More specifically, the present invention relates to immersion coolants for immersion cooling systems.

### BACKGROUND OF THE INVENTION

With the advanced technology in today's society, computer equipment has become an indispensable part of human life. The amount of electricity used of the computer equipment are also very considerable. In recent years, the development and application of many high-performance computers (such as e-sports computers, quantum computers, mining computers, edge computing computers, big data processing computers, etc.) have exerted great influence on society and changed the way of human life. This shows the importance of computers in the future life of mankind. Since the generation of heat is an inevitable phenomenon in the operation of computer hardware, and the operating efficiency of the computer will decrease with the increase of the temperature of the server, in order to maintain the best computer efficiency and improve the efficiency of electricity consumption, the cooling system of the computer plays a role played a very important role. The development of low-cost and high-efficiency cooling systems has also become a very important.

The mechanism of the computer cooling system is mainly to use the external medium to contact and absorb the heat energy generated by the host hardware, and then transfer the heat energy from the inside of the system to the outside through the flow of the medium to achieve the purpose of dissipating heat energy and reducing the temperature. At present, most of the computer system cooling uses air and water as the heat dissipation medium. In a typical air-cooled cooling system, the heat is conducted from the CPU of the computer host through the applied thermal paste to the copper or aluminum thermally conductive base plate, and then moves from the base plate into the connected heat pipe, and finally the warm air is blown away by the connected fan on the computer. In some other typical methods, computer cooling can also use liquid as a medium, which is called a water-cooled system. The water-cooled process is similar to the air-cooled type. The heat is conducted from the computer to the metal base plate, and the metal surface of the base plate is in direct contact with the water-cooled head. When the coolant flows through the water-cooled head, the coolant will absorb the heat from the base plate.

By flowing in the pipeline, the endothermic cooling liquid is brought into the cooling device, and then the heat is blown away from the cooler by a fan, and the cooling liquid is re-circulated in the water-cooling device. A good cooling system has played a very important role in the technological development of improving computer performance in the past. Thus, a better and more efficient cooling system and method are needed.

### SUMMARY OF THE INVENTION

The mineral oil coolant disclosed herein can be used in an immersive cooling system to improve the efficiency of electronic equipment and be applied to high-performance computers required for 5G mobile communications and artificial intelligence. This system can be further used for the heat dissipation of electric vehicle batteries and power transmission systems, helping to make proper use of electricity and energy storage. Energy-saving and carbon-reduction is a global industrial development trend, which meets the needs of corporate ESG management, reduces international economic obstacles, and is also beneficial to industrial development of characteristic technologies.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1A shows that estimated by 2030, the power required by the information and communication industry will increase by 20.9% each year, and most of the demand growth comes from data centers.

FIG. 1B shows that, in terms of the power demand of the data center, the cooling system of the computer accounts for about 40% of the total power consumption.

FIG. 2 shows the method of immersion cooling is to directly immerse the server in a non-conductive liquid in accordance with some embodiments.

FIG. 3A shows a coolant chemical structure that is used for the immersion cooling system in accordance with some embodiments.

FIG. 3B shows the monomer 1-decene used in accordance with some embodiments.

FIG. 4A and 4B show the side chain of the poly(1-decene) polymer and 1-decene polymer used in accordance with some embodiments.

FIG. 4C shows the short carbon chain fatty alcohols or fatty acids themselves form dimers through hydrogen bonds, and then distribute between the side chains of the poly(1-decene) polymer in accordance with some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

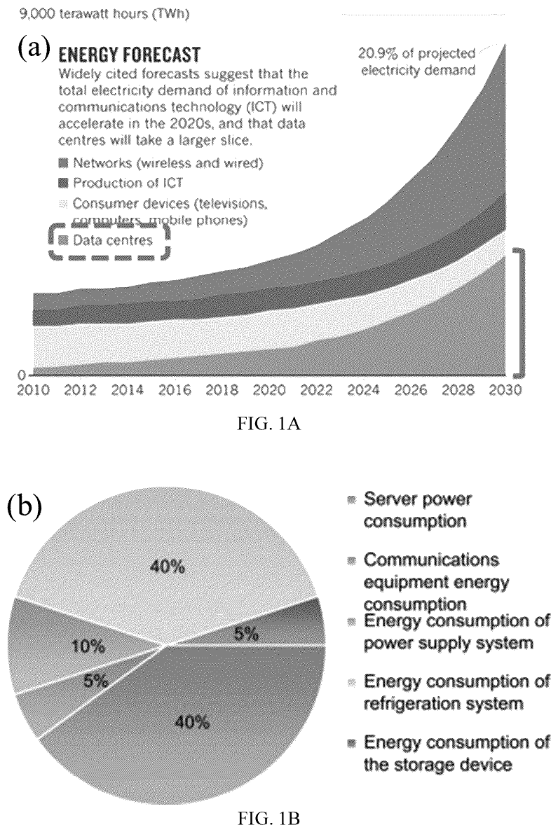

FIG. 1A shows that it is estimated that by 2030, the power required by the information and communication industry will increase by 20.9% each year, and most of the demand growth comes from data centers. Depending on the level of technological development, the annual power demand of the data center will increase to 8,000 TWh at most and 1,100 TWh at least.

FIG. 1B shows that, in terms of the power demand of the data center, the cooling system of the computer accounts for about 40% of the total power consumption. The traditional air-cooled and water-cooled types have gradually failed to meet the cooling needs. Therefore, the immersion cooling system with better cooling capacity has become the main computer cooling solution for high-power data centers, and it also contributes to energy saving and carbon reduction, which is in line with the development of governments around the world to reduce carbon emissions.

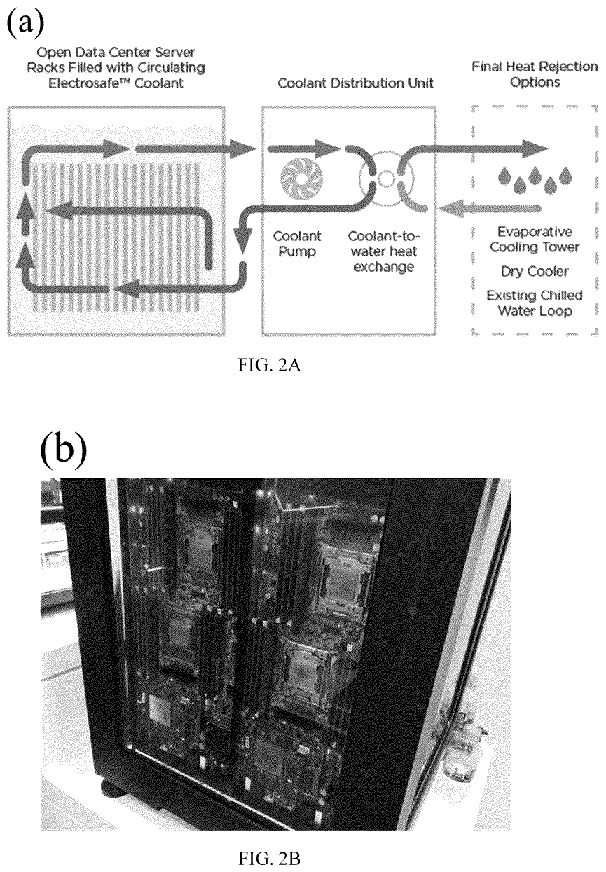

FIG. 2 shows the method of immersion cooling is to directly immerse the server in a non-conductive liquid to directly transfer the heat generated by the computer host to the liquid, without the need for oth er active cooling components such as heat sinks, heat pipes or fans. The liquid after absorbing heat will flow back to the system to absorb heat energy through the circulating cooling method, which can greatly improve the performance of the computer and the efficiency of energy use. Through the immersion cooling technology, the host can be isolated from the external environment, and the heat dissipation does not need to consider the factors of traditional air convection, so the configuration design of the server can be more compact, creating a better hardware density. And because this system does not need to use a fan, it can greatly reduce the indoor noise generated when the computer is in use. Furthermore, the immersion cooling system eliminates the need for externally cooled components, which also reduces the number of components that need to be repaired for a computer host. Based on these advantages, immersion cooling related technology has its importance in development Several factors that affect the effectiveness and efficiency of immersion cooling methods include the type of coolant, the design of the system flow path, and the speed at which the coolant flows. It can be seen that the properties of the coolant play a crucial role in the development of an immersion cooling system. The electronic coolants are divided into two categories. The first category is mineral oil coolant, and the second category is fluorine-based coolant. Mineral oil was first produced and sold as insulating coolant by the General Electric Company as early as 1892. The main reason for using mineral oil is its high flash point, and it is widely produced and used in the world with low cost of use. The characteristics of mineral oil are that it has a high boiling point and is not volatile. The container used in the cooling system does not need to be sealed. After use, the computer device is easy to take out and put back in. The disadvantage is that the mineral oil attached after taking out is viscous and difficult to handle, causing cleaning. and maintenance hassles. In addition, the high flash point of the mineral oil is relatively high viscosity, the fluidity in the system is relatively poor, the motor of the cooling system needs to pay more energy to achieve the ideal coolant flow rate. On the other hand, the fluorine-based coolant was proposed by 3M in the 1980s. It is characterized by good thermal stability and chemical stability, and its appearance is transparent and has good fluidity. After use, there is no need to worry about the adhesion problem on the device. However, because of the low boiling point, the container used in the cooling system needs to be sealed to prevent volatilization, and it is very difficult to remove and put back the computer device during cooling. And because fluorine-containing compounds are stable and difficult to decompose, if they leak into the atmosphere due to poor sealing, it will aggravate the greenhouse effect and cause climate change.

Table 1 summarizes the advantages and disadvantages of mineral oil coolants and fluorine-based coolants. From the perspective of market sales, the current price of fluorine-based coolants per liter is as high as $170USD/per liter, and higher specifications are required for system packaging. If the immersion cooling system uses fluorine-based coolant, it is not easy to popularize due to its high cost.

Therefore, if a mineral oil coolant with low viscosity, high flash point and insulation can be developed, there is a good opportunity to make the mineral oil coolant based immersion cooling system that is competitive in the market, which is advantageous in the aspects that it further improve the performance of the computer and reduce the use of electricity.

TABLE 1
Comparison of the advantages and disadvantages of
mineral oil coolant and fluorine coolant

| | Advantages | Disadvantageous |
|---|---|---|
| Mineral | High Flash Point, Low Cost, | High viscosity, hard to clean |
| Oil | No need to seal the cooling | and maintenance, low |
| Coolant | system, and devices are easy | fluidability, higher energy |
| | to be removed | consumption |
| Florine | Transparent fluid, better | High Costs, Need to seal the |
| Based | flowability, high chemical | cooling system, hard to break |
| Coolant | stability, and easy to clean | down chemicals, global |
| | | warming contributor when |
| | | leaks |

This disclosure uses polyalphaolefins (PAOs) as a base chemical with the addition of fatty alcohols and fatty acid molecules with shorter carbon chains to reduce the force between mineral oil molecules of PASs, which reduces the viscosity of the mineral oil itself. Fatty alcohol and fatty acid molecules themselves have high boiling point and low conductivity, and they maintain the flash point and conductivity of the original polyolefin mineral oil. As a result, a mixture of the three develops a mineral oil coolant with low viscosity, high flash point and insulation.

Present Disclosure uses polyolefin mineral oils of different carbon chain lengths mixing with different chemicals with short carbon chain molecules, which reduce the force between the base mineral oil molecules (e.g., PAOs), thereby reducing the viscosity of the oil.

Nonetheless, the short carbon chain mineral oil has a low flash point, which can affect the thermal stability of the mineral oil.

Thus, adding short carbon chain fatty alcohols and fatty acid molecules with high boiling point and low conductivity are used to reduce the viscosity of mineral oil and maintain the thermal stability of the oil. At the same time, the cost of mineral oil is low, and the prices of fatty alcohols and fatty acids used in this project are not high, so the market price for mineral oil upgrading and development is relatively competitive.

Present Disclosure, in accordance with some embodiments, reduces the force between mineral oil molecules of PAOs by adding fatty alcohols and fatty acid molecules with shorter carbon chains, thereby reducing the viscosity of mineral oil itself. Fatty alcohols and fatty acid molecules themselves have high boiling points and low electrical conductivity, and are able to maintain the flash point and electrical conductivity of the original mineral oil.

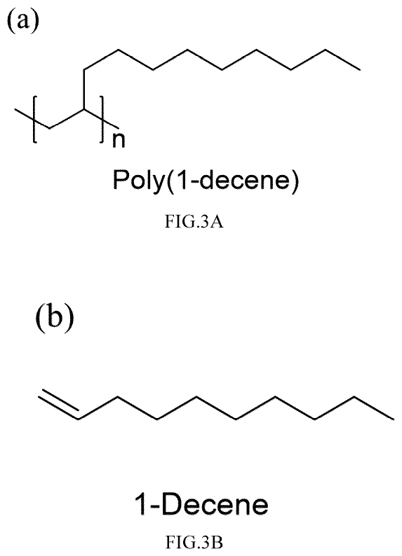

FIG. 3A shows, in some embodiments, a coolant used for the immersion cooling system, which is a PAO2 based mineral oil, wherein the main component is Poly(1-decene).

FIG. 3B shows the monomer 1-decene, which is produced by polymerization and hydrogenation.

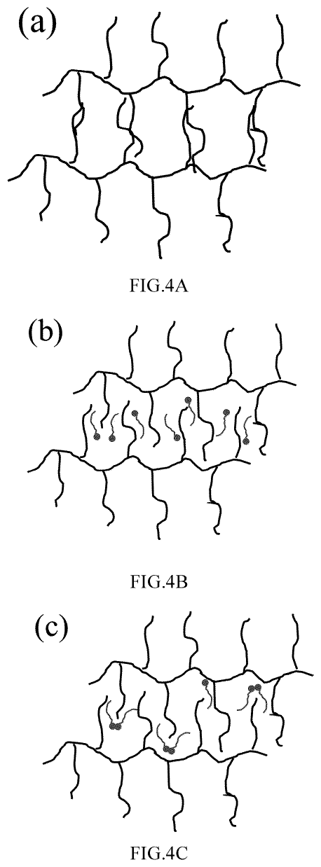

FIG. 4A shows the side chain of the poly(1-decene) polymer, which is a long alkane chain composed of 9 carbon atoms. The different poly(1-decene) molecules interact through the staggering interaction between the long alkane chains. Since the chains are staggered together, the viscosity increases.

As shown in FIG. 4B, when a short carbon chain fatty alcohol or fatty acid is mixed with poly(1-decene), the distance between the molecules is reduced due to the small hydrophobic interaction between the short carbon chain molecule and the larger poly(1-decene) side chain, so the overall viscosity decreases. In other words, the short carbon chain fatty alcohol, fatty acid, or both reduces the crossover interaction among the long carbon chain of the poly(1-decene).

FIG. 4C shows the short carbon chain fatty alcohols or fatty acids themselves form dimers through hydrogen bonds, and then distribute between the side chains of the poly(1-decene) polymer, thus limiting the interactions among the long alkane chains. The hydrophobic interaction force between them increases, so the distance between the molecules increases, and the overall viscosity decrease.

In some embodiments, 10% butanol, heptanol, decanol, lauryl alcohol, hexanoic acid, and capric acid (decanoic acid), individually or in a combination thereof, is mixed/added to PAO2 mineral oil, stirred at room temperature for 2 hours, and then the viscosity of the mineral oil is measured with an Oswald viscometer. Since the viscosity measurement is affected by the temperature on the day of measurement, the viscosity measured is compared on different days with the viscosity of the unadded PAO 2 mineral oil, and the viscosity of the PAO 2 mineral oil measured on the day is set as 1, the corrected viscosity of mineral oil with added fatty alcohol or fatty acid is shown in Table 1 below. When PAO 2 mineral oil is mixed with four-or seven-carbon fatty alcohols, namely butanol or heptanol, the overall viscosity decreased by 16.6% and 9.2%, respectively, compared with ten-carbon decanol or twelve carbons, after mixing with lauryl alcohol, the overall viscosity increased by 18.0% and 30.5% respectively. On the other hand, the overall viscosity of PAO 2 mineral oil decreased by 8.5% when mixed with six-carbon fatty acid hexanoic acid, and increased by 15.3% when mixed with ten-carbon decanoic acid. As a result, six-carbon fatty acid hexanoic acid shows an unexpected result.

In some embodiments, adding a fatty alcohol or fatty acid with a carbon chain length of less than nine carbons, which is the side chain length of poly(1-decene), the main component of PAO2 mineral oil, can effectively reduce the viscosity of mineral oil. In the experiment of adding fatty alcohol, the degree of influence of fatty alcohol on viscosity depends on the carbon chain length, and the mineral oil with the shortest carbon chain butanol reduces the viscosity the most (16.6%). Conversely, the mineral oil with the longest carbon chain lauryl alcohol increased the viscosity the most (30.5%). The above provides a method of manipulating (e.g., reducing or increasing) the viscosity of mineral oil.

TABLE 2
PAO 2 mineral oil viscosity with added fatty alcohol or fatty acid.

| Cooling oil | Calibrated Viscosity |
|---|---|
| PAO 2 | 1 |
| PAO 2 + 10% butanol (C4) | 0.834 (−16.6%) |
| PAO 2 + 10% heptanol (C7) | 0.908 (−9.2%) |
| PAO 2 + 10% decyl alcohol (C10) | 1.180 (+18.0%) |
| PAO 2 + 10% lauryl alcohol (C12) | 1.305 (+30.5%) |
| PAO 2 + 10% hexanoic acid (C6) | 0.915 (−8.5%) |
| PAO 2 + 10% decanoic acid (C10) | 1.153 (+15.3%) |

In some embodiments, different short carbon chain additives are mixed with PAO2 mineral oils are used as a controlling factor in controlling and manipulating the viscosity, flash points among other selected physical property of the coolants. The types of additives that are used are shown in the Table 2. In some embodiments, the added alcohols and/or acids are between 5% and 50%. In some embodiments, the added alcohols and/or acids are between 1% and 70%. In some embodiments, the added alcohols and/or acids are between 9% and 15%.

In addition to the above-mentioned fatty alcohols and fatty acid molecules, long alkane-chain ketones (e.g., carbon chain length 4-7 carbons or 8-15 carbons), naphthenic molecules, and branched long-chain alkanes are used to control the viscosity of mineral oil.

In addition to viscosity, conductivity and flash point of mineral oils with additives are factors in selecting additives. Conductivity and flash point have a lot to do with the long-term safety of mineral oil.

TABLE 3
Selected additives of various functional groups,
molecular weights, density, and flash points.

| | Molecular | | Boiling |
|---|---|---|---|
| | Weight | Density | Point |
| Additive | (g/mol) | (g/cm³) | (° C.) |
| Butanol | 74.12 | 0.8098 | 117.7 |
| Hexnaol | 102.17 | 0.8136 | 155 |
| Heptanol | 116.2 | 0.8187 | 175.8 |
| Octanol | 130.23 | 0.824 | 195 |
| Decyl alcohol | 158.28 | 0.83 | 232.9 |
| Lauryl alcohol | 186.34 | 0.831 | 259 |
| Butyric acid | 88.11 | 0.96 | 163.5 |
| Hexanoic acid | 116.16 | 0.92 | 202 |
| Octanoic acid | 144.21 | 0.91 | 237 |
| Decanoic acid | 172.26 | 0.89 | 269 |
| Dodecanedioic acid | 230.3 | 1/066 | 220 |
| Butanone | 72.11 | 0.805 | 80 |
| 2-Hexanone | 100.161 | 0.811 | 127.6 |
| 2-Octanone | 128.21 | 0.82 | 172.5 |
| 2-Decanone | 156.26 | 0.825 | 211 |
| 2-Dodecanone | 184.32 | 0.828 | 247 |
| Cyclopentane | 70.1 | 0.751 | 49 |
| Cyclohexane | 84.16 | 0.7739 | 80.74 |
| Cyclopentanone | 84.12 | 0.95 | 130.6 |
| Cyclohexanone | 98.15 | 0.9478 | 155.65 |
| Cyclopentanecarbosylic acid | 114.14 | 1.053 | 216 |
| Cyclohexanecarboxylic acid | 128.17 | 1.034 | 235 |
| 3-Ethylhexane | 114.23 | 0.72 | 119 |
| 3-Ethyloctane | 142.28 | 0.1 | 166.5 |
| 3-Ethyldecane | 170.33 | 0.8 | 209.8 |
| 1,3-Cyclopentanedione | 98.10 | 1.38 | 150 |
| 1,4-Cyclohexanedione | 112.127 | 1.127 | 226 |
| Additive | Molecular | | Boiling |
| | Weight | Density | Point |
| | (g/mol) | (g/cm³) | (° C.) |

TABLE 4

| Item | Fast Cool mix #01 | Fast Cool mix #02 |
|---|---|---|
| PAO2 Molecular formula | 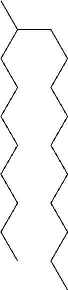 [SMILES: CCCCCCCCCCC(C)CCCCCCCC] | |
| | 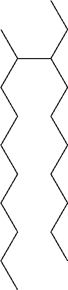 [SMILES: CCCCCCCCC(C)C(CC)CCCCCCC] | |
| | 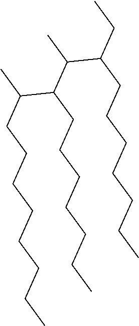 [SMILES: CCCCCCCCC(C)C(CCCCCCC)C(C)C(CC)CCCCCCC] | |
| | 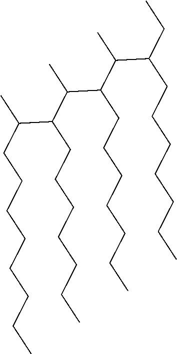 [SMILES: CCCCCCCCC(C)C(CCCCCCC)C(C)C(CCCCCCC)C(C)C(CC)CCCCCCC] | |
| PAO2.5 Molecular formula | 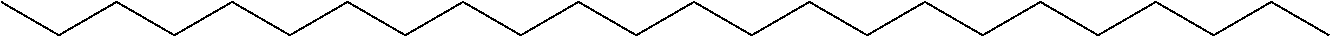 [SMILES: CCCCCCCCCCCCCCCCCCCCCCCC] | |
| | 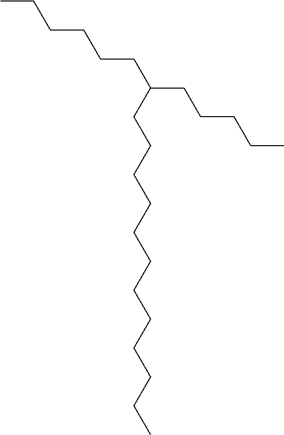 [SMILES: CCCCCCCCCCCCC(CCCCC)CCCCCC] | |
| | 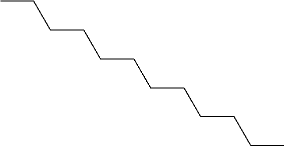 | |
| | 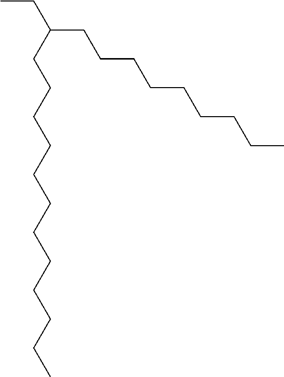 [SMILES: CCCCCCCCCCCCC(CC)CCCCCCCCC] | |
| PAO6 Molecular formula | 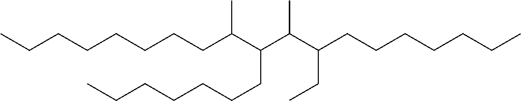 [SMILES: CCCCCCCCC(C)C(CCCCCCC)C(C)C(CC)CCCCCCC] | |
| | 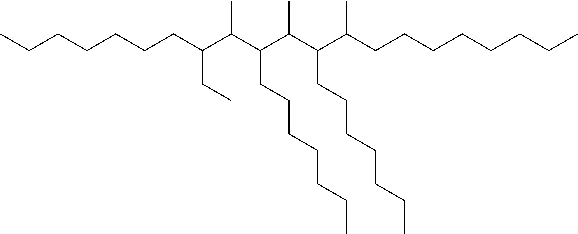 [SMILES: CCCCCCCCC(C)C(CCCCCCC)C(C)C(CCCCCCC)C(C)C(CC)CCCCCCC] | |
| | PAO2/PAO6 48:52 | PAO 2.5/PAO6 45:55 |
| Viscosity at 100° C. | 3.49 | 3.57 |
| 40° C. | 14.4 | 14.53 |
| Viscosity index | 126.9 | 129.7 |
| Flash point ° C. | 178 | 208 |
| Specific Gravity @ 25 C, | 0.81 | 0.82 |
| g/ml | | |
| Dielectric Strength (KV) | 13 | 17 |

In order to obtain a lower viscosity and a higher flash point, 3 kinds of PAO, PAO2, PAO 2.5 and PAO6 were used for mixing experiments, and 2 kinds of mixing ratios were obtained by many fine-tuning, namely Fast Cool Mix #01 and Fast Cool Mix #02. These two data have the expected effect which viscosity is 3.4˜3.5 (at 100° C.) and flash point is in range from 170˜210° C. This parameter allows cooling system to select the appropriate pump and heat exchanger.

In operation, low-viscosity mineral oil cooling with maintaining the conductivity and flash point of PAO 2 mineral oil is used as a coolant for a computing system, which also use different ratios of additives to adjust the special coolant suitable for the immersion cooling system.

In utilization, the coolant in accordance with some embodiments can not only be used in computer systems to dissipate heat and improve operating efficiency, it is also used for cooling and protection of large batteries, which is of great importance to the development of electric vehicles and the national grid. important goals for the development of the country.

Applicants include gaming console, edge computing device, and electronic equipment. The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

1. A mineral oil based coolant for immersion cooling systems comprising:
a. polyalphaolefins; and
b. a modifier that lower the viscosity of the of the polyalphaolefins when mixed with the polyalphaolefins
wherein the modifier is 5%-20% by weight of the mineral oil based coolant and comprises four-seven carbon fatty acids or fatty alchols.

2. The coolant of claim 1, wherein the polyalphaolefins comprises poly(1-decene).

3-5. (canceled)

6. The coolant of claim 1, wherein the four-seven carbon fatty alcohols comprise butanol or heptanol.

7. (canceled)

8. The coolant of claim 1, wherein the modifier comprises 4-10 carbon chain including alkane-chain ketones, naphthenic molecules, or branched long-chain alkanes.

9-20. (canceled)
